(19) United States
(12) Patent Application Publication
(10) Pub. No.: US 2009/0051132 A1
(43) Pub. Date: Feb. 26, 2009

(54) LOAD MOVER

(76) Inventors: Jeirenne Galloway Masterson, Lake Jackson, TX (US); Joe Rex Epps, II, Lake Jackson, TX (US); James Harold Moses, Liverpool, TX (US); John B. Shoemaker, Leander, TX (US)

Correspondence Address: CHRISTIE, PARKER & HALE, LLP, PO BOX 7068, PASADENA, CA, 91109-7068, US

(21) Appl. No.: 12/032,461

(22) Filed: Feb. 15, 2008

Related U.S. Application Data
(60) Provisional application No. 60/901,970, filed on Feb. 15, 2007.

(51) Int. Cl. B62B 17/00

(52) U.S. Cl. 280/19

(57) ABSTRACT

Apparatus for moving a load includes a flexible plastic sheet having a leading edge, a trailing edge, and two side edges. An elongated rigid element is secured to the leading edge of the sheet adjacent a hand opening through the sheet to provide a handle for pulling the mover when a load is on it.

### CROSS-REFERENCE TO RELATED APPLICATION

This application claims the benefit of U.S. Provisional Application No. 60/901,970 filed Feb. 15, 2007 and entitled HAULING APPARATUS, the entire content of which is hereby expressly incorporated by reference.

### BACKGROUND OF THE INVENTION

This invention relates to apparatus for moving a load by sliding it from one location to another.

### SUMMARY OF THE INVENTION

The load mover of this invention includes a relatively thin, durable, and flexible sheet having a generally planar surface upon which a load may be placed in order to move the load. The sheet includes a leading edge, a trailing edge, and two side edges. An elongated rigid element is secured to the leading edge of the sheet to provide a handle for pulling the sheet when the load is on it. In one embodiment of the invention, the handle is secured directly to the sheet. A handle opening may be provided extending through the sheet adjacent the handle to provide a convenient way for grasping the mover to pull it when the load is on it. The handle thus provides a comfortable way to exert a pulling force on the mover. The handle also reinforces the flexible sheet in the vicinity of the handle opening to spread the applied force over a relatively large area, and hold the sheet flat in the area of the handle to minimize material fatigue and extend the life of the mover. In addition, the handle holds the sheet flat to prevent a loose load such as a load of soil or gravel from flexing the sheet such that a portion of the load is funneled off the back of the sheet at the trailing end.

The handle can be provided in any suitable form. For example, it can be formed from a pair of half-round segments fastened to opposite sides of the sheet adjacent the handle opening. The segments can be held in place by fasteners such as screws or by a suitable adhesive. In one embodiment, the half-round elements are extruded or molded as a single piece with the two plastic segments integrally joined to one another by a living hinge. In another embodiment, the elongated rigid element is a handle extruded integrally with the leading edge of the sheet to provide a stiffening action along the entire length of the leading edge. The handle opening may be formed through the sheet by any one of various methods such as by rule die or metal punch. In the embodiment of the invention in which the elongated rigid element is molded integrally with the leading edge of the sheet, the sheet may be thicker in the vicinity of the rigid element and thinner throughout the rest of the sheet. This provides maximum strength in the area of the sheet that is subject to the most stress during use.

In yet another embodiment of the invention, a pair of laterally spaced holes extends through the sheet adjacent the leading edge. An elongated rigid element in the shape of a segment of pipe may be used in combination with the sheet, extending between the holes, and according to this embodiment, has a length the distance between the centers of the holes. The pipe segment may be secured to the leading edge of the sheet by an elongated laterally flexible connector, such as a rope or strap. The connector extends through the pipe with each of two ends extending through a respective hole adjacent to the leading edge of the sheet. The ends of the flexible connector may be secured together so the pipe and flexible connector form a handle for pulling the mover. The pipe segment on the sheet prevents the sheet from curling up around an axis perpendicular to the pipe segment as the mover is pulled. The distal part of the connector may also extend through a second pipe segment to provide a comfortable grip for pulling the mover when the load is on it.

One embodiment of the mover of this invention also includes holes through the sheet adjacent the trailing edge. Such holes can be useful as grips to assist in carrying the mover, may also be used to hang the mover against a flat surface for storage, or to assist in moving loads as will be described in detail below.

### BRIEF DESCRIPTION OF THE DRAWINGS

FIG. 1 is a perspective view of one embodiment of the mover of this invention;

FIG. 2 is an enlarged fragmentary plan view of the handle portion of the mover shown in FIG. 1;

FIG. 3 is a sectional view taken on line 3-3 of FIG. 2;

FIG. 4 is a plan view showing an alternate embodiment of the mover of this invention with a pair of handles at the leading edge and a pair of handle openings along one side edge of the mover;

FIG. 5 is a perspective view of an embodiment of the mover in which the handle is extruded in one piece with a pair of elongated half-rounds integrally joined by a living hinge;

FIG. 6 is a view taken on line 6-6 of FIG. 5;

FIG. 7 is an end view of the extruded handle of the embodiment shown in FIGS. 5 and 6 before the handle is attached to the sheet of the mover;

FIG. 8 is an end view of the handle immediately after extrusion, and before it has cooled to the final form shown in FIG. 7;

FIG. 9 is a plan view of an embodiment of the mover of this invention in which the handle is extruded integrally with the sheet to extend across substantially the entire width of the leading edge of the mover;

FIG. 10 is a view taken on line 10-10 of FIG. 9;

FIG. 11 is a perspective view of the embodiment of FIG. 5 using a pair of pipe segments and a rope to provide a handle and rigidity to the trailing end of the mover; and

FIG. 12 is a perspective view of the embodiment shown in FIG. 11 with the rope and extended handle disposed to form a toggle arrangement for moving a load.

### DETAILED DESCRIPTION OF THE INVENTION

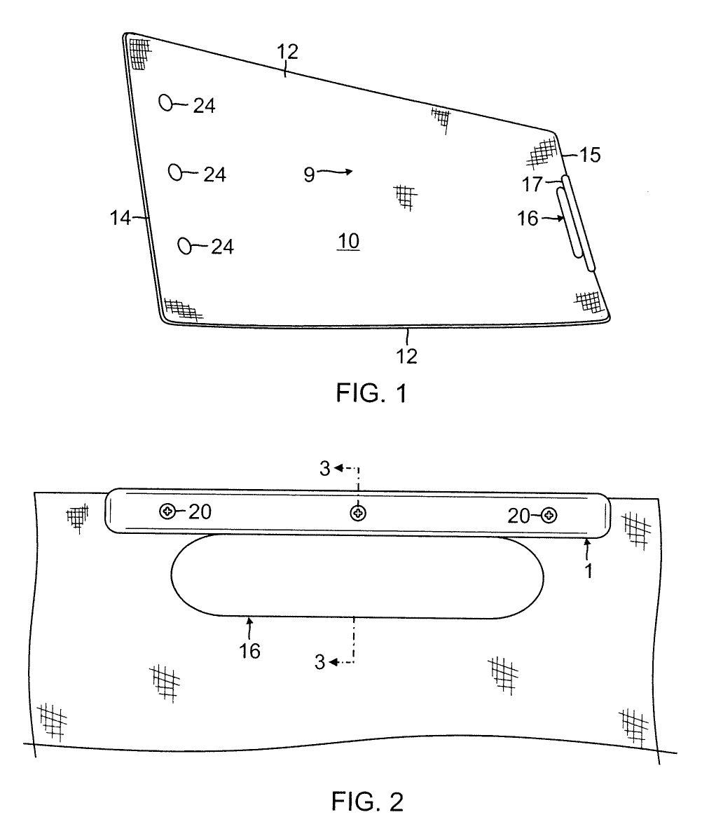

Referring to FIG. 1, a mover 9 includes a flexible elongated sheet 10 of high density polyethylene plastic, or any other suitable flexible material. The sheet has parallel side edges 12 and parallel trailing and leading edges 14 and 15, respectively. The sheet is rounded at each corner to facilitate ease of use and safe handling. A load (not shown) may be rested on the upper surface of the sheet. An elongated handle opening 16 extends through the sheet adjacent and parallel to the leading end edge of the sheet to provide a convenient way to grasp the sheet to slide the mover with the load over a supporting surface, such as a lawn, floor, driveway, deck, or the like. The handle opening can be of any convenient size, such as, about two inches wide and about nine inches long. According to one embodiment, the handle opening is curved at each end to resist damage to the sheet when the mover is used to move a heavy load.

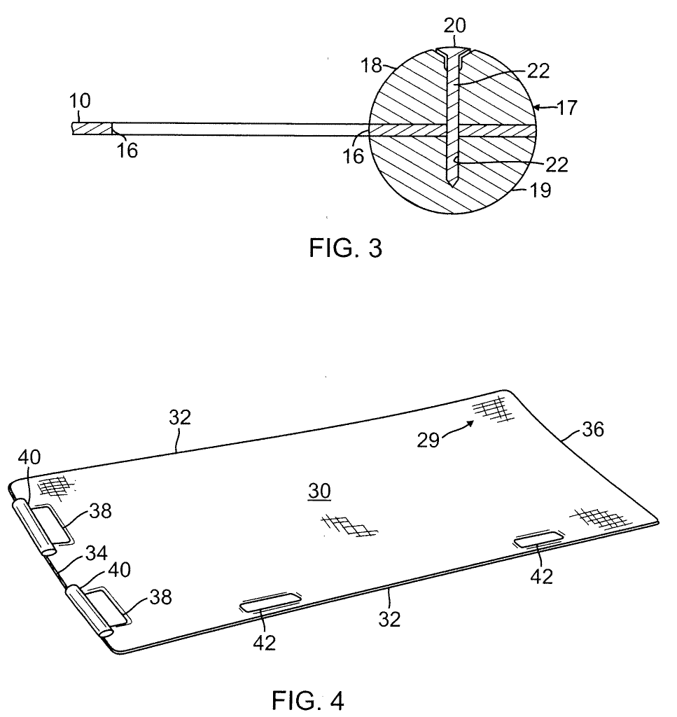

As shown in FIGS. 1, and 3, a handle 17 is secured to the leading edge 15 of the sheet. The handle serves as an elongated rigid stiffening element, and includes an elongated upper half-round strip 18 secured to a matching lower elongated half-round strip 19 at the edge of the sheet adjacent the handle opening 16 so the leading edge 15 of the sheet is clamped between the two half-round strips. The half-round strips are slightly longer than, and centered on, the handle opening 16. The upper half-round strip is secured to the lower half-round strip, by any suitable adhesive or fasteners. In this embodiment, three stainless steel flat head screws 20 are threaded into respective bores 22 (FIG. 3) in the half-round strips to secure the half-round strips to the undrilled sheet. The bores 22 in the upper half-round strip are each counter-sunk to receive the head of a respective screw, and extend entirely through the upper half-round strip. The bores 22 in the lower half-round strip extend from the flat surface to a distance about three quarters of the way through the lower half-round strip. The inner edges of the half-round strips are nearly flush with the outer edge of the handle opening to provide a comfortable grip for grasping and pulling the sheet when a load is to be moved. The half-round strips also provide stiffening and reinforcing for the sheet to resist tearing and material fatigue when the sheet is pulled. As explained in more detail below, the stiffening provided by the handle minimizes curling of the sheet about an axis perpendicular to the handle when the mover is used in certain ways as described below. The half-round strips can be made of any suitable material, such as a high-strength plastic. In one embodiment, they are made of extruded high density, polyethylene plastic.

Referring to FIG. 1, three circular holes 24 may extend through the sheet adjacent the trailing end edge 14. For this embodiment, each hole is equidistant from an adjacent hole or a side edge of the sheet. The holes 24 provide a convenient way to hang the sheet flat when not in use such that the mover uses very little storage space. The holes 24 may also be used as finger holes to move and adjust the sheet during use, or can be used to carry the mover in a teardrop shape by first grasping handle 17 in the palm of the hand then placing one or more fingers through the center hole 24 of trailing edge 14. A rope may also be threaded through the holes 24, around a load, and then through hand hole 16, with the option of wrapping the rope around handle 17. Loads may alternately be secured by threading a rope through the central hole 24 or corner holes 24, causing the sheet to curl trailing edge 14 around the load toward the leading edge 15, and threading the rope through hand hole 16, with the option of wrapping the rope around the handle 17.

The sheet can be of any appropriate size, though in general, sheets larger than about ten feet in length or four feet in width become too cumbersome to maneuver by hand. The sheet may be made of any suitable flexible material such as plastic. According to one embodiment, high density polyethylene is used for the sheet. A suitable high density polyethylene is one with physical properties as set forth in the following table:

| | | | |
|---|---|---|---|
| Property | Method | Units | Value |

Typical Property Values of High Density Polyethylene Sheet 1/8″ Thick

| | | | |
|---|---|---|---|
| ASTM Type, Class, Category | ASTM D1248 | — | IV, A, 4 |
| Melt Index | ASTM D1238 | g/10 min. | 0.70 |
| Density | ASTM D1505 | g/cm³ | .960 |
| Hardness | ASTM D2240 | Shore D | 68 |
| Tensile Strength @ Break | ASTM D638 | psi | 4.400 |
| Elongation @ Break | ASTM D638 | % | >600 |
| Flexural Modulus | ASTM D790 | psi | 220,000 |
| 1% Scant Modulus | ASTM D790 | psi | — |
| Tensile Impact, (2) | ASTM D1822 | ft-lb/in | 100 |
| Environment Stress Crack | ASTM D1693 | hrs. | — |
| Resistance, F50 | ASTM D2561 | hrs. | — |
| Low Temperature Brittleness, F50 | ASTM D746 | ° C. | <.76 |
| Heat Deflection Temperature @ 66 PSI | ASTM D648 | ° C. | 78 |
| Vical Softening Point | ASTM D1525 | ° C. | 125 |

Black Pipe Grade High Density Polyethylene

| | | | |
|---|---|---|---|
| ASTM Type, Class, Category, Grade | ASTM D1248 | — | III, A, 5, P34 |
| Cell Classification | ASTM D3350 | — | 345, 434 |
| PPI Recommended Designation | — | PE 3408 | — |
| Density | ASTM D792 | g/cm² | .957 |
| Melting Point | ASTM D3417 | ° F. | 260 |
| Reduced Specific Viscosity (RSV) | ASTM D1601 | dl/g | 3.0 |
| Melt Flow Indices 190° C./5 kg | ASTM D1238 | g/10 min | 0.4 |
| Melt Flow Indices 109° C./21.6 kg (HM1) | ASTM D1238 | g/10 min | 10 |
| Hydrostatic Design Basis 100,000 hrs. 73° F. (23° C.) | ASTM D2837 | psi | 1,600 |
| Compressed Ring ESCR (50° C./25% Igepal) | ASTM F1248 | hrs. | >1,000 (no failures) |
| Rockwell Hardness | ASTM D785 | L Scale | 49 |
| Shore Hardness | ASTM D2240 | Shore D | 63 |
| ESCR (100% Igepal) | ASTM D1693C | hrs. | >5,000 (no failures) |
| Izod Impact Strength (Notched) | ASTM D256A§ | ft-lb/in | 8 |
| Tensile Strength @ Yield | ASTM D638‡ | psi | >3,300 |
| Elongation @ Break | ASTM D638‡ | % | >800 |
| Scant Modulus of Elasticity @ 2% Strain | ASTM D638‡ | psi | 115,000 |
| Flexural Modulus @ 2% Strain | ASTM D3350 | psi | 125,000 |
| Vicat Softening Point | ASTM D1525 | ° F. | 255 |
| Brittleness Temperature | ASTM D746 | ° F. | −180 |
| Heaf Distortion Temperature | ASTM D648 | ° F. | 172 |
| Thermal Expansion | ASTM D696 | in/in/° F. | 1 × 10⁻¹ |

The sheet can be of any suitable thickness, say between about 1/32″ and about 3/16″. Preferably, the physical properties of the sheet, and the thickness of the sheet, are such that the hardness of the sheet resists local deformation by objects placed on the sheet, or by irregularities in the surface which supports the sheet, and yet is sufficiently flexible so the sheet can easily be curled about an axis perpendicular to the side edges. According to one embodiment, the sheet is sufficiently flexible that it may be curled to have a radius of curvature less than about 6″. This flexibility is important because, among other things, it permits the sheet of the mover to be curved about a transverse axis into a U-shape, which increases the utility of the mover for handling various types of loads as described below. The flexibility also permits the mover to be rolled into a relatively small cylinder for compact storage when not in use. A convenient size of the sheet for the embodiment shown in FIGS. 1-3 is from about four to six feet in length and about two to three feet in width.

FIG. 4 shows an alternate embodiment of a mover 29 of this invention in which a rectangular flexible sheet 30 of high density polyethylene is about 1/16 inch thick. The sheet includes parallel side edges 32 each about five and one-half feet long and parallel leading and trailing edges 34, 36 respectively, which are each about two and one-half feet long. Larger sized sheets may be useful for moving large items, or for towing items, say behind a mower or small tractor. A pair of elongated rectangular handle openings 38 through the sheet 30 adjacent the leading edge facilitate pulling the sheet. A separate, elongated stiff handle 40 is secured to the leading edge of the sheet adjacent each handle opening 38. The handles 40 are constructed and mounted on sheet 30 as described above for the handle 17 shown in FIGS. 1 and 3. A pair of longitudinally spaced rectangular openings 42 adjacent one of the side edges 32 of the sheet 30 provide side handles for pulling the sheet laterally with respect to its longitudinal axis. This facilitates slipping the sheet out from under objects (not shown in FIG. 4) loaded on it. The side handle openings 42 can be of any convenient size, such as 2 inches by 9 inches.

The mover of this invention is useful for handling a great variety of objects. For example, gardeners or landscape architects can use it to move heavy pots, bags of mulch, fertilizer, or soil. Firewood, log and limbs, stones, and pavers are also conveniently moved with the apparatus of this invention. Swimming pool service providers and swimming pool owners find it useful for moving bags and containers of pool chemicals. It can further be used to move heavy items such as four hundred- to six hundred-pound chain barrels on concrete surfaces, or to move heavy equipment such as air conditioner units. The mover can also be used as a liner to protect truck beds or car trunks from chemicals or other materials while transporting objects and to ease loading of heavy objects into vehicles. Hunters can even use the mover to haul animal carcasses.

The mover of this invention is also useful indoors in offices, warehouses, laboratories, and homes for moving boxes, furniture, file cabinets, equipment, and the like. Using the mover is better than a dolly in many respects because objects do not have to be lifted up on wheels. While objects may be lifted onto the mover, in some circumstances, it is easier to tilt the load, then wheel, walked, roll, push, or drag the load onto the sheet. Because the sheet is more rigid along the axis perpendicular to the leading and trailing edges, the sheet can also be shoved underneath the load. As more of the load is maneuvered onto the low-friction sheet, it becomes easier to move the load on. Furthermore, because the sheet is so thin, the load has a lower overall height, and can more easily clear doorways. Additionally, the load has a lower center of gravity, reducing the risk of tipping, and the load cannot fall from the height of the wheels.

The coefficient of friction of the sheet is so low with respect to most support surfaces that even heavy objects are easily moved, and can easily be shoved across the sheet to a desired position. A mover of this invention made with a plastic sheet as described herein tends to retain its low coefficient of sliding friction even after months of use over rough surfaces. For example, a force of only 35 pounds is required to pull a 135 pound weight on the mover over a ceramic tiled surface. A force of only 20 pounds pulls a 50 pound load on the mover over a grass lawn, and a force of approximately 75 pounds pulls a 250 pound load on the mover over a concrete driveway.

A user can sit or kneel on the leading edge of the mover while weeding. The mover acts as a sit-upon so the user stays clean and dry while pulling weeds and placing them on the trailing end of the mover. The user can stand up, pull the mover to a new location and weed some more. When the weed pile is high, the user can pick up the mover at the leading and trailing edges to form a U. The weeds slide to the middle of the mover, and are ready to dump into a trash pile, trash bag, or garbage can. Debris can also be raked or swept onto the mover like a large dust pan, and the mover can be bent into a U to dump the debris.

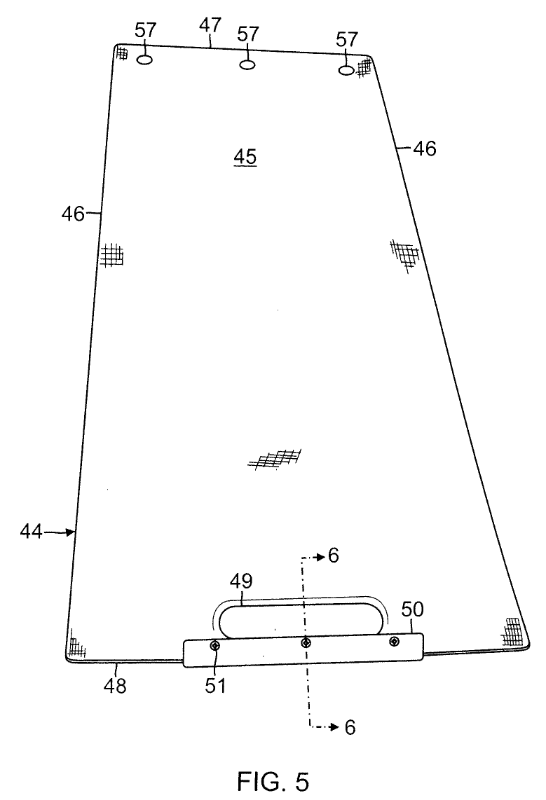

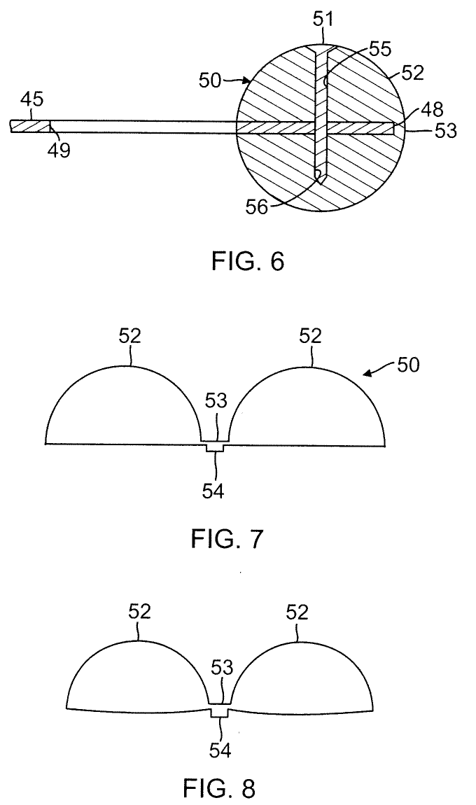

Referring to FIG. 5, a mover 44 includes a flexible elongated, rectangular sheet 45 of high density polyethylene plastic. The sheet has parallel side edges 46 and parallel trailing and leading edges 47 and 48, respectively. An elongated handle opening 49 through the sheet adjacent and parallel to the leading end edge is spaced a short distance from that edge. An elongated, generally cylindrical handle 50 is secured to the center of the leading end edge by flat head screws 51 as shown best in FIG. 6. The handle 50 of this embodiment includes two elongated semi-circular segments 52, each in the shape of a generally half-round strip, and connected at adjacent edges by a living hinge 53 formed integrally with adjacent edges of the two generally semi-circular segments 52.

In one embodiment, the handle is made of high density polyethylene plastic extruded to the desired shape as described below. FIG. 7 shows the handle after it has been extruded and cooled, and before it is folded about the living hinge into the orientation shown in FIG. 6 to clamp the leading end edge of sheet 45. With the two half round segments in the open position as shown in FIG. 7, the flat surfaces of the segments lie in a common plane, and the living hinge includes a longitudinal ridge 54 which projects slightly below that common plane. Thus, when the half round segments 50 are folded about the living hinge 53 to the clamping position shown in FIG. 6, the ridge 54 abuts the leading edge 48 of sheet 45, and insures that the flat surfaces of the half round segments are parallel to each other and to the opposite faces of the sheet 45 clamped between them.

In one embodiment, the half-round segments are drilled to provide bores 55, 56 in the upper and lower (as viewed in FIG. 6) segments of the handle, respectively, so that the upper segment is completely penetrated by bore 55, and the lower segment is penetrated from the flat surface to about three quarters of the radius of the lower segment. In one embodiment, bores 55 and 56 are drilled with the handle held in the clamping position shown in FIG. 6, but before being slipped over the leading edge of sheet 45. The upper end of each bore 55 is countersunk to receive the head of a respective screw 51. After the bores are drilled, the handle is placed in the position shown in FIG. 6 to clamp the leading edge of sheet 45, and screws 51 are inserted in respective bores 55 and 56. Thus, the screws penetrate the undrilled sheet and force displaced sheet material into any available space in the handle bores or between the sheet and flat surfaces of the half-round segments, thus creating a tighter, more secure attachment. The advantage of the handle shown in FIGS. 5-7 is that it can be extruded or molded in a single piece for greater manufacturing consistency and assembly efficiency.

High density polyethylene plastic is extruded at a temperature of about 380° F., and tends to shrink slightly on cooling. Accordingly, the generally semi-circular segments 52 may be extruded as shown in cross-section in FIG. 8 so that the flat surfaces of the half round segments are slightly convex. On cooling, the flat surfaces are substantially co-planar as shown in FIG. 7. For example, if the radius of each generally semi-cylindrical segment 52 is about 0.55 inches, the flat surface of each segment bows slightly to form a convex surface so the center of each such surface is displaced about 0.02 inches from the common plane referred to above with respect to FIG. 7. When the molded handle slowly air-cools, the flat surfaces of the segments shrink slightly to be substantially co-planar as shown in FIG. 7.

As with the movers shown in FIGS. 1 through 4, the handle applied to the mover shown in FIGS. 5 through 7 provides reinforcing in the vicinity of handle opening 49 so that the sheet 45 can be relatively thin, large and flexible, and yet not be damaged due to the application of relatively large pulling forces applied to the handle. This not only results in longer life for the mover, but also substantially reduces the amount of plastic required for sheet 45, thus creating a mover that is large, lightweight, easy to maneuver, easy to load, and safe to use. The handle not only spreads the force applied to the sheet for pulling, but it also provides stiffness which keeps the sheet relatively flat to resist excessive curling and flexing, which would result in premature fatigue of the material.

It should be noted that while a generally cylindrical handle is disclosed, the invention is not limited to such handles. Variations on the shape of the handle are possible and may include handles of harder or softer materials with generally elliptical or oval cross-sections, or of any other shape that provides a good and comfortable gripping surface.

The mover shown in the embodiment of FIG. 5 also includes three laterally spaced holes adjacent the trailing edge of sheet 45. One of the holes 57 is on the longitudinal center line of the sheet, and each of the other holes 57 is adjacent a respective side edge. These holes are useful for various purposes as described elsewhere.

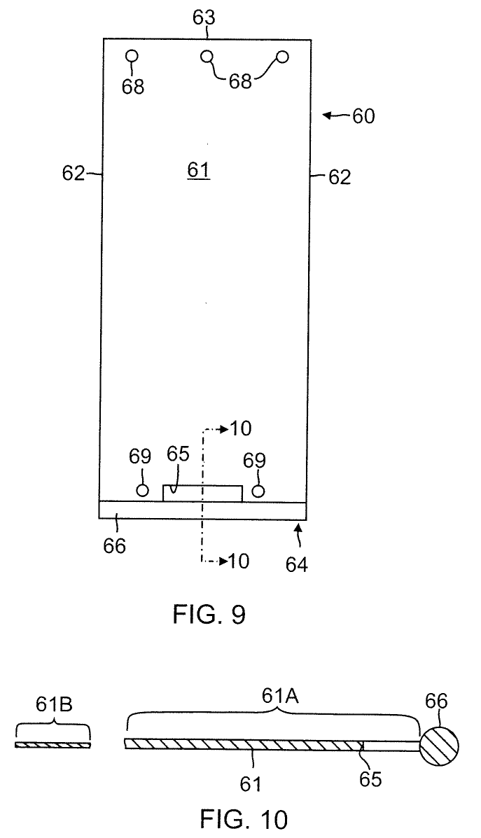

Referring to the embodiment of FIGS. 9 and 10, a mover 60 includes a flexible elongated generally rectangular sheet 61 of extruded high density polyethylene plastic with parallel side edges 62 and parallel trailing and leading edges 63, 64, respectively. An elongated handle opening 65 extends through the sheet adjacent the leading edge. An elongated cylindrical handle 66 is molded integrally with the leading edge of the sheet to provide a rigid element which holds the sheet flat in that area, provides a comfortable means for grasping the mover to pull it, and spreads the pulling force over a wide area of the sheet so that it can be relatively thin and not be damaged. The sheet may be extruded in a direction perpendicular to the side edges 62, for example, through a die which forms a sheet slightly thicker in the vicinity of the leading edge, and of a lesser thickness throughout most of the rest of the sheet. For example, if the sheet is about 8 feet long, an area 61A of the sheet within about a foot of the handle has a thickness of ⅛ inch, and the sheet gradually tapers in the direction of the trailing edge so that an area 61B within about 6 inches of the trailing edge of the sheet has a thickness of approximately 1/32 of an inch. Of course, the sheet can also have a uniform thickness as described above with respect to the other movers of this invention.

The diameter and cross-sectional shape of the handle 66 can be any suitable dimension. For most users, a generally cylindrical handle with a diameter of about 1 inch provides a comfortable handle for gripping, resists curling of the sheet about an axis extending in the longitudinal direction of the sheet, and distributes the applied force over a wide area of the sheet for maximum life with minimum use of material.

The flexibility of the sheet also enables it to conform to the shape of the load to better secure the load and to create a rotation diameter of the mover which roughly corresponds to the footprint of the load itself. Three laterally spaced holes 68 may be provided, extending through the sheet 61 adjacent the trailing edge of the mover, and on a line generally perpendicular to the side edges and about 2 inches from the trailing edge of the mover. In this embodiment, one of the holes 68 is on the longitudinal center line of the mover, and each of the other holes is located about 2 inches from a respective side edge. A pair of openings 69 extend through the sheet on a line which passes through the center of the handle opening and perpendicular to the side edges of the mover. Each hole 69 is about 5 inches from a respective side edge when the mover has a width of about 2 feet. Holes 69 may be used to center a rope or strap used to effectively extend the useable length of the sheet 61, which rope or strap may be threaded through a pipe segment for comfortable pulling.

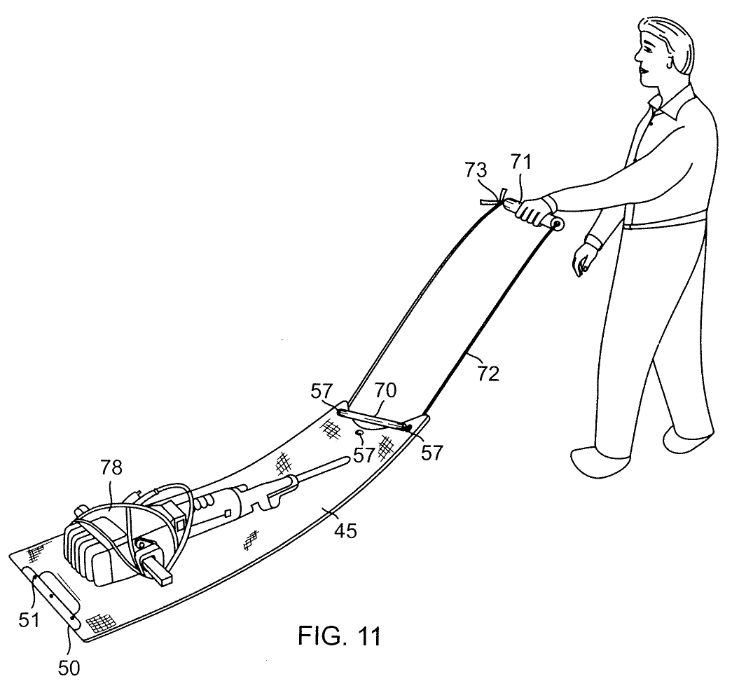

FIG. 11 shows the mover of FIG. 5 being used with first and second pipe segments 70 and 71 secured by a rope 72 to the trailing edge of the mover to move a heavy tool 78 on sheet 45 of the mover. The first pipe segment 70 is disposed on the upper surface of the sheet, and has a length approximately equal to the distance between the centers of the two outboard holes 57 (and shown best in FIG. 5). The rope extends through first pipe segment 70 and down through a respective opening 57 at each end of the pipe segment. The rope also extends through second pipe segment 71, and the free ends of the rope are secured together such as by a knot 73 so the rope forms an elongated flexible connector which secures the two pipe segments to the mover. The first pipe segment 70 limits the amount of curvature which can be imposed on the sheet about the longitudinal axis of the mover as a pulling force is exerted on the second pipe segment.

With this arrangement, the end of the mover which is normally considered to be the trailing edge becomes the leading edge, and the end of the mover which was previously the leading edge now becomes the trailing edge. Moreover, the handle 50 may also serve as a chock to prevent the load from sliding off the trailing edge of the mover as the sheet is dragged over a supporting surface; however, handle 50 is not a required element for using the mover in this configuration because pipe segment 70 provides the rigid element on the now-leading edge. The pipe segments work together to limit the curvature imposed on the sheet, and limit the localized forces at each hole through which the rope extends. While the second pipe segment is not required for pulling, it helps hold the loop of rope in an open condition so that opposite legs of the rope are substantially parallel to the side edges of the mover to assist in limiting the curvature imposed on the sheet, and also provides a comfortable handle for pulling the mover at a comfortable and efficient angle.

While a rope is illustrated, the rope can be replaced with straps, such as straps of nylon or polyethylene webbing equipped with appropriate buckles, snaps, or the like. Such fasteners can be used to facilitate quick adjustment of the flexible connector to any desired length for accommodating various loads. Such ropes and straps may also be connected to handle 50 to effectively extend the useable length of the sheet as described elsewhere.

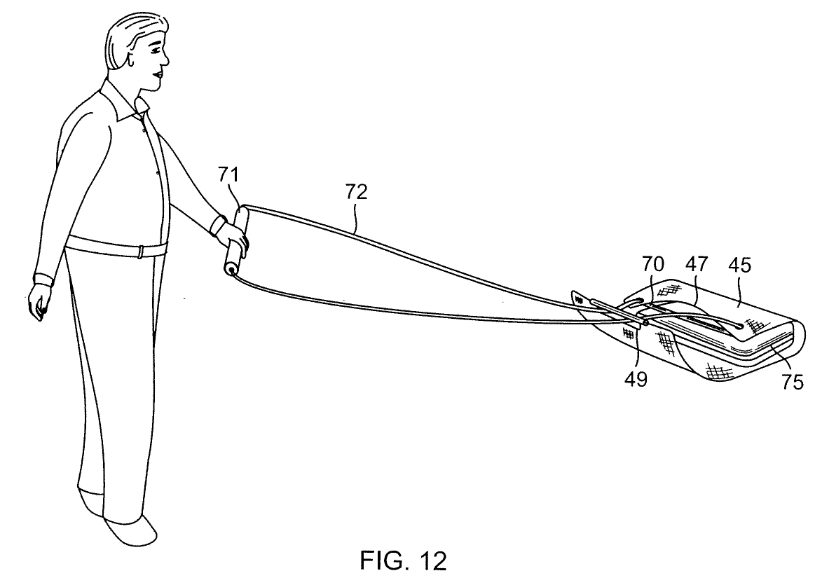

FIG. 12 shows the apparatus of FIGS. 5 and 11 used in a toggle arrangement in which the rope 72 is threaded down through the handle opening 49 so the trailing edge 47 of the sheet 45 curves up over a load 75 on the top surface of the sheet. The first pipe segment 70 keeps the trailing end of the sheet 45 substantially flat as the mover is pulled by applying force to the second pipe segment 71.

In a variation, rather than using a second pipe segment, the rope may pass around the hips of a user or alternately, under the arms of the user, so that the user can apply maximum pulling force on the mover and safely use major muscle groups. With reference to FIG. 9, a rope can be looped through handle opening 65 on mover 60. The forward end of the rope passes under the arms of a user, and across the back of the neck of the user, such as is done with a backpack. Thus, the user, in a standing position and facing away from the mover, can apply maximum pulling force to the mover.

While the invention has been described with reference to certain specific embodiments, variations would be apparent to one of ordinary skill. Embodiments may include various configurations of holes for ropes or straps and various configurations of hand holes, which also may serve as holes for ropes or straps. The holes may optionally include one or more rigid elements and rigid elements may be attached or removable along the full length or partial length of the sheet on leading, trailing, or side edges. Therefore, the scope of the invention is not to be limited to any specific embodiment, but rather, by the following claims.

What is claimed is:

1. Apparatus for moving a load, the apparatus comprising:
a flexible plastic sheet defining a surface for receiving the load and having a leading edge and a trailing edge; and
a handle secured to the leading edge of the sheet and adapted to allow the pulling of the sheet with the load on it.

2. Apparatus according to claim 1 further including a handle opening extending through the sheet adjacent the handle.

3. Apparatus according to claim 2 in which the handle comprises two elongated strips secured to opposite sides of the sheet.

4. Apparatus according to claim 3 in which the strips are generally half-round strips secured together to form a handle having a generally circular cross-section adjacent the handle opening.

5. Apparatus according to claim 4 in which the half-rounds are formed of extruded plastic integrally joined by a living hinge.

6. Apparatus according to claim 3 in which the elongated strips are secured together by screws.

7. Apparatus according to claim 3 in which the strips are secured to the sheet by adhesive.

8. Apparatus according to claim 2 in which the sheet and rigid element are formed of plastic and integrally formed as a single piece.

9. Apparatus according to claim 8 in which the sheet is thicker adjacent the leading edge than adjacent the trailing edge.

10. Apparatus according to claim 9 in which the major part of the sheet has a first thickness that is less than a second thickness of a minor part of the sheet.

11. Apparatus according to claim 1 further comprising:
a pair of laterally spaced holes through the sheet adjacent the leading edge;
a pipe segment adapted to be placed on the sheet in between the holes; and
a flexible connector extending through the pipe segment and the holes to secure the pipe segment to the sheet.

12. Apparatus according to claim 11 further comprising a second pipe segment adapted to be spaced from the sheet, and through which the flexible connector extends to form a handle.

13. Apparatus according to claim 1 further including a plurality of handle openings, at least one of which extends through the sheet adjacent the handle.

14. Apparatus for moving a load, the apparatus comprising:
a flexible plastic sheet defining a top surface for receiving the load and a bottom surface adapted to slide against a ground surface, the flexible plastic sheet further defining a leading edge and a trailing edge;
a handle opening extending through the sheet toward the leading edge
a handle secured to the leading edge of the sheet and adjacent the handle opening, wherein the handle and handle opening are together adapted to allow the pulling of the flexible plastic sheet in order to slide the flexible plastic sheet and the object along the ground surface.

15. Apparatus according to claim 14 in which the handle comprises two elongated strips secured to opposite sides of the sheet.

16. Apparatus according to claim 15 in which the strips are generally half-round strips secured together to form a handle having a generally circular cross-section adjacent the handle opening.

17. Apparatus according to claim 16 in which the half-rounds are formed of extruded plastic integrally joined by a living hinge.

18. Apparatus according to claim 16 in which the elongated strips are secured together by screws.

19. Apparatus according to claim 16 in which the strips are secured to the sheet by adhesive.

20. Apparatus according to claim 14, wherein the handle opening is a first handle opening, the apparatus further comprising at least one additional handle opening.
